(19) United States
(12) Patent Application Publication
(10) Pub. No.: US 2024/0397861 A1
(43) Pub. Date: Dec. 5, 2024

(54) Handheld work apparatus

(71) Applicant: Andreas Stihl AG & Co. KG, Waiblingen (DE)

(72) Inventors: Timo Förg, Aspach (DE); Cornelius Gindele, Plochingen (DE)

(73) Assignee: Andreas Stihl AG & Co. KG, Waiblingen (DE)

(21) Appl. No.: 18/677,963

(22) Filed: May 30, 2024

(30) Foreign Application Priority Data
Jun. 1, 2023 (DE) 102023114436.7

(51) Int. Cl. A01D 34/78; A01D 34/90

(52) U.S. Cl. CPC A01D 34/78; A01D 34/90

(57) ABSTRACT

A handheld work apparatus includes a housing with an upper housing part and a lower housing part, an electric motor arranged in the housing. A rotor shaft of the rotor is mounted relative to the housing by means of a first bearing and a second bearing so as to be rotatable about an axis of rotation. The rotor shaft extends in the direction of the axis of rotation from the upper housing part into the lower housing part. The first bearing is held by the upper housing part. The second bearing is held by the lower housing part, a receptacle formed at least partially on the upper housing part for fastening a tube to the housing— The upper housing part and the lower housing part at least partially overlap the stator in the direction of the axis of rotation.

### CROSS-REFERENCE TO RELATED APPLICATION

This application claims the benefit of German Patent Application DE 102023114436.7, filed on Jun. 1, 2023, the content of which is incorporated in its entirety.

### BACKGROUND

Handheld work apparatuses such as grass trimmers, brush cutters, hedge trimmers and lawn mowers are used to cut grass, branches, undergrowth, or the like. For this purpose, a tool is driven, which cuts the vegetation to be cut when it comes into contact with the tool. Mowing heads with a cutting line and/or cutting knife, cutting blades, saw blades, or the like can be used as a tool.

Such work apparatuses have a housing in which a drive motor designed as an electric motor is provided, which serves to drive a tool. The housing is provided with a receptacle for attaching a tube. The work apparatus is held and guided on the tube. Due to the transmission of forces and torques between the housing and the tube, the work apparatus is subject to high loads. A disadvantage of known work apparatuses is that such loads can lead to a considerable shortening of the service life of such a work apparatus.

### SUMMARY

The present application provides a work apparatus which enables a high load-bearing capacity and thus also a long service life of the work apparatus.

The handheld work apparatus comprises a housing with an upper housing part and a lower housing part. A drive motor is arranged in the housing. The drive motor is an electric motor with a stator and a rotor. The stator is connected to the housing. A rotor shaft of the rotor is mounted relative to the housing by a first bearing and a second bearing so as to be rotatable about an axis of rotation. The rotor shaft extends in the direction of the axis of rotation from the upper housing part into the lower housing part. The first bearing is held by the upper housing part. The second bearing is held by the lower housing part. A receptacle is formed at least partially on the upper housing part for fastening a tube to the housing. The upper housing part and the lower housing part at least partially overlap the stator in the direction of the axis of rotation of the rotor.

When the work apparatus is guided by the tube, the loads acting on the housing are transferred from the upper housing part to the tube. Since the upper housing part at least partially overlaps the stator, the housing part is at least indirectly supported on the stator, whereby the rigidity of the housing, in particular of the upper housing part, is increased. The stiffening of the housing by the stator enables the housing to withstand high loads. Furthermore, the increased component stiffness can have a positive effect on the service life of the work apparatus.

Particularly preferably, the upper housing part and the lower housing part have a separating plane in the region of the stator that runs transversely to the axis of rotation of the electric motor. Preferably, the first bearing and the second bearing are arranged opposite each other with respect to the separating plane. Preferably, the first bearing is overmolded or pressed into the upper housing part. Preferably, the second bearing is overmolded or pressed into the lower housing part. Particularly preferably, the first bearing is overmolded or pressed into the upper housing part and the second bearing is overmolded or pressed into the lower housing part. In an alternative configuration, it could also be provided to use the first bearing and/or the second bearing in a separate component. The separate component can then be fastened to the housing, for example, via a screw connection.

It is advantageously provided that the upper housing part and/or the lower housing part are made of plastic. Due to the stiffening of the housing by means of the stator, a material for forming the housing can also be provided, which has a lower strength compared to metal materials. Alternatively, however, it is also conceivable to provide the upper housing part and/or the lower housing part from a metal material.

It is preferably provided that the stator is pressed into the upper housing part. The stator is particularly preferably pressed into the lower housing part. The stator is particularly advantageously pressed into the upper housing part and into the lower housing part.

Preferably, the upper housing part and the lower housing part are centered with respect to one another via the stator. This ensures simple assembly and economical production of the work apparatus, as additional centering devices are not required. The stator preferably has a centering section on its circumference. The stator preferably makes direct contact with the lower housing part and/or the upper housing part via the centering section. In an alternative configuration, however, it can also be provided that a further component is provided between the centering section of the stator and the housing. This component can be, for example, a ring-shaped component which surrounds the stator and is intended for centering the two housing halves with the stator. In such a configuration, the lower housing part and the upper housing part are centered with respect to one another only indirectly via the centering section of the stator.

Due to the centering section of the stator and the corresponding counter-contour in the lower housing part or the upper housing part, a bearing for the rotor that is pressed into or overmolded in the lower housing part or the upper housing part can be aligned in a simple and reliable manner coaxially with the stator and the other bearing, thereby achieving a uniform air gap between the stator and the rotor. This is particularly advantageous if the electric motor is not mounted as an assembly on the housing, but the stator and rotor are mounted individually on the housing.

The stator is preferably attached to the lower housing part by a screw connection. The stator is preferably pressed and screwed into the lower housing part. The upper housing part is preferably pressed onto the stator and screwed to the lower housing part.

It is particularly advantageously provided that the receptacle for fastening the tube is formed from the upper housing part and the lower housing part. In this way, force is transmitted between the two housing parts and the tube. In a preferred embodiment of the work apparatus, a damping unit is provided on the receptacle, the damping unit being arranged functionally between the tube and the receptacle.

It is advantageously provided that the centering section of the stator has a length measured in the direction of the axis of rotation of the rotor. The upper housing part contacts the stator on the centering section via a first contact surface. The upper housing part overlaps the centering section of the stator with its first contact surface in the direction of the axis of rotation of the rotor in a first overlap section. The length of the first overlap section measured in the direction of the axis of rotation corresponds to at least 20%, preferably at least 35%, in particular approximately 50%, of the length of the stator. The longer the overlap section, the more the stator stiffens the upper housing part.

Further features of the invention will become apparent from the description and the drawings, which show an exemplary embodiment of the invention described in detail below.

### BRIEF DESCRIPTION OF THE DRAWINGS

FIG. 1 is a side view of a handheld work apparatus.

FIG. 2 is a partial plan view of the housing of the work apparatus according to FIG. 1.

FIG. 3 is a sectional view along the line between the arrows A according to FIG. 2 showing the housing with pressed-in stator and with receptacle for fastening the tube.

FIG. 4 is a further sectional view along the line between the arrows B according to FIG. 2 showing the housing with stator.

FIG. 5 is a sectional view along the line between the arrows C according to FIG. 4 showing the stator pressed into and screwed to the lower housing part.

FIG. 6 shows a perspective view of the lower housing part.

FIG. 7 shows a perspective view of the upper housing part.

### DETAILED DESCRIPTION

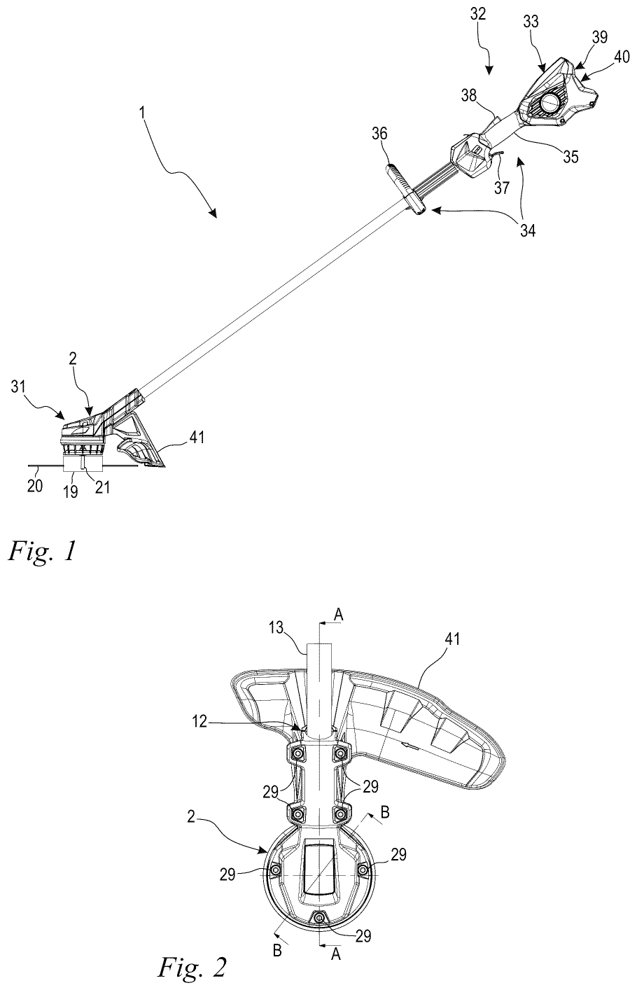

FIG. 1 shows a side view of a handheld work apparatus—hereinafter referred to as a work apparatus. The work apparatus is particularly preferably designed as a handheld, portable work apparatus. The term “portable work apparatus” refers to a work apparatus that is designed in such a way that it can be carried and operated by hand by the operator during its intended use. The work apparatus 1 is designed as a brush cutter.

As shown in FIG. 1, the work apparatus 1 comprises a housing 2. A drive motor, which is designed as an electric motor 5, is arranged in the housing 2. The electric motor 5 serves to drive a cutting tool 20, which is shown schematically in FIG. 1. The cutting tool 20 is designed as a cutting line which is attached to a mowing head 19. The mowing head 19 is driven in rotation together with the cutting tool 20 via an output shaft 21. The cutting tool 20, which in the present embodiment is designed as a cutting line, is used for cutting vegetation such as grass, undergrowth, or the like.

The work apparatus 1 has a front end 31 and a rear end 32. The front end 31 is formed by the housing 2. A receptacle 12 is provided on the housing 2. A tube 13 is fastened to the housing 2 via the receptacle 12. The tube 13 extends to the rear end 32 of the work apparatus 1, which is formed by a rear housing 33. A handle unit 34 is provided on the rear housing 33 and/or the tube 13, which serves to guide the work apparatus 1. The handle unit 34 comprises a rear, first handle 35 and a front, second handle 36. The first handle 35 is associated with an operating lever 37 for controlling the speed of the drive motor 5. Furthermore, the first handle 35 is associated with a blocking lever 38 for releasing and locking the operating lever 37. The term “associated” is to be understood as meaning that the levers associated to the handle are arranged opposite the handle in such a way that they can be operated with the hand resting on the handle. The operating lever 37 and/or the blocking lever 38 are advantageously part of the first handle 35. However, it can also be provided that the operating lever 37 and/or the blocking lever 38 are located outside the first handle 35. The second handle 36, which is designed as a loop handle, is arranged at a distance from the first handle 35 towards the front end 31 of the work apparatus 1. Furthermore, the rear housing 33 comprises a battery compartment 39 in which at least one battery pack 40 is arranged as an electrical energy source for the drive motor 5. The housing 2 and the rear housing 33 are connected to one another by the tube 13. The tube 13 can also be designed as a telescopic tube. In an alternative embodiment, the work apparatus 1 can in principle also be designed as another tube apparatus, for example as a pole pruner. The mowing head 19 is covered by a protective hood 41 in the direction of the handle unit 34. The protective hood 41 is attached to the housing 2.

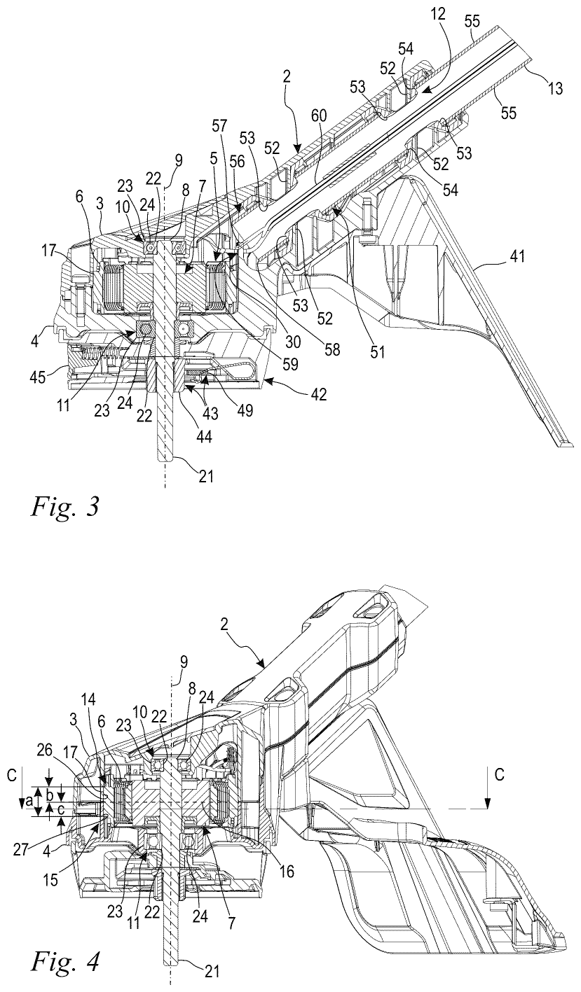

FIG. 2 shows a sectional view of the housing 2 with the protective hood 41 and with a section of the tube 13. FIG. 2 shows section lines A-A, B-B of the sectional illustrations according to FIGS. 3 and 4.

FIG. 3 shows the housing 2 of the work apparatus 1 in a sectional view along the section line A-A according to FIG. 2. The housing 2 comprises an upper housing part 3 and a lower housing part 4. The electric motor 5 is arranged in the housing 2 and is held between the upper housing part 3 and the lower housing part 4. The electric motor 5 comprises a stator 6, which is connected to the housing 2. The rotor 7 has a rotor shaft 8, which is mounted so as to be rotatable about an axis of rotation 9 with respect to the housing 2. In the present embodiment of the work apparatus 1, the electric motor 5 is designed as an internal rotor motor. The rotor 7 rotates in relation to the axis of rotation 9 of the rotor shaft 8, in particular radially within the stator 6. The rotor shaft 8 extends in the direction of the axis of rotation 9 from the upper housing part 3 into the lower housing part 4. In the exemplary embodiment, the rotor shaft 8 forms the output shaft 21. In an alternative embodiment, it can also be provided that the output shaft 21 is designed as a separate shaft that is driven by the rotor shaft 8 of the rotor 7. It can also be provided that the rotor shaft 8 drives a transmission for providing a translational output movement.

The housing 2 of the work apparatus 1 forms an outer housing of the work apparatus and at the same time a motor housing for the drive motor 5. An outer housing is to be understood as a housing that closes off the work apparatus from its external environment. The housing 2 is the only housing that encloses the drive motor 5. The rotor shaft 8 of the drive motor 5 preferably protrudes from the housing 2. The housing 2 encloses the drive motor 5 in such a way that the drive motor 5 has a solid angle range of at least 30% of the total solid angle with respect to a point on the axis of rotation 9 of the rotor shaft 8 in the region of the stator 6 of the housing 2.

As shown in FIGS. 3 and 4, the rotor shaft 8 is mounted so as to be rotatable relative to the housing 2 via a first bearing 10 and a second bearing 11. The first bearing 10 and the second bearing 11 are arranged at a distance from each other. The first bearing 10 is held by the upper housing part 3. The first bearing 10 is in particular arranged completely in the upper housing part 3. The second bearing 11 is held by the lower housing part 4. The second bearing 11 is preferably arranged in the lower housing part 4, in particular completely. The first bearing 10 and/or the second bearing 11 are preferably designed as rolling bearings. Other bearing types may also be used in alternative designs. The first bearing 10 and the second bearing 11 each comprise an inner ring 22, an outer ring 23 and rolling elements 24 arranged between the inner ring 22 and the outer ring 23. The outer rings 23 of the two bearings 10, 11 contact the upper housing part 3 and the lower housing part 4, respectively. The inner rings 22 of the two bearings 10, 11 contact the rotor shaft 8. In an alternative embodiment, it may also be expedient to dispense with the outer ring 23 and/or the inner ring 22. In the present exemplary embodiment, the housing parts 3, 4 are made of plastic. The first bearing 10, in particular the outer ring 23 of the first bearing 10, is preferably overmolded in the upper housing part 3. The second bearing 11, in particular the outer ring 23 of the second bearing 11, is preferably overmolded in the lower housing part 4. In an alternative embodiment, it can also be provided that the bearings 10, 11 are pressed into the respective housing parts 3, 4. In a further, alternative embodiment, it can also be provided that the bearings 10, 11 are each fastened to a separate component, which in turn is fastened to the respective housing part 3, 4, for example by means of a screw connection.

As shown in FIGS. 3 and 4, the upper housing part 3 overlaps the stator 6 in the direction of the axis of rotation 9 of the rotor shaft 8. In the present exemplary embodiment, both the upper housing part 3 and the lower housing part 4 contact the stator at a centering section 17. Thus, both the upper housing part 3 and the lower housing part 4 are directly connected to the stator 6. The centering section 17 is formed on the circumference of the stator 6. In an alternative embodiment, it may also be expedient to provide a further, for example ring-shaped, component between the stator 6 and the upper housing part 3 and/or the lower housing part 4, which serves to connect the stator 6 and the upper housing part 3 and/or the lower housing part 4. In such an embodiment, the stator 6 is only indirectly connected to the upper housing part 3 and/or the lower housing part 4 via the further component.

As shown in particular in FIG. 4, the upper housing part 3 and the lower housing part 4 are aligned with respect to one another via the centering section 17 of the stator 6. For this purpose, the upper housing part 3 includes at least one first contact surface 26 that bears against the centering section 17 of the stator 6. The at least one first contact surface 26 faces the axis of rotation 9 of the rotor shaft 8. The lower housing part 4 includes at least one second contact surface 27 that bears against the centering section 17 of the stator 6. The at least one second contact surface 27 faces the axis of rotation 9 of the rotor shaft 8. The contact between the contact surfaces 26, 27 of the housing parts 3, 4 and the centering section 17 of the stator 6 reinforces each of the housing parts 3, 4. A transmission of forces and torques can thus take place between the housing parts 3, 4 and the stator 6. By stiffening the housing parts 3, 4, forces acting on the housing 2 are absorbed by the stator 6 and evenly distributed to the housing 2. This ensures an even distribution of forces and torques. The centering section 17 of the stator 6 therefore has a dual function, namely, on the one hand, to center the two housing halves 3, 4 with respect to one another and, on the other hand, to stiffen them.

As shown in FIG. 4, the centering section 17 of the stator 6 has a total length a measured in the direction of the axis of rotation 9 of the rotor shaft 8. The upper housing part 3 at least partially overlaps the centering section 17 of the stator 6 in the direction of the axis of rotation 9 of the rotor shaft 8 with the first contact surface 26 in a first overlap section 14. The first overlap section 14 has a length b measured in the direction of the axis of rotation 9 of the rotor shaft 8. The length b of the first overlap section 14 preferably corresponds to at least 20%, preferably at least 35%, in particular approximately 50%, of the length a of the stator 6.

As shown in FIG. 4, the second contact surface 26 of the second lower housing part 4 at least partially overlaps the centering section 17 of the stator 6 in the direction of the axis of rotation 9 of the rotor shaft 8 in a second overlap section 15. The second overlap section 15 has a length c measured in the direction of the axis of rotation 9 of the rotor shaft 8. The length c of the second overlap section 15 preferably corresponds to at least 20%, preferably at least 35%, in particular approximately 50%, of the length a of the stator 6. Particularly preferably, the lengths a, b of the first overlap section 14 and of the second overlap section 15 are the same. Furthermore, the work apparatus 1 comprises a separating plane 16. The separating plane 16 is aligned transversely, in particular perpendicular, to the axis of rotation 9 of the rotor shaft 8. The separating plane 16 runs between the upper housing part 3 and the lower housing part 4. The separating plane 16 runs between the overlap sections 14, 15 of the two housing halves 3, 4.

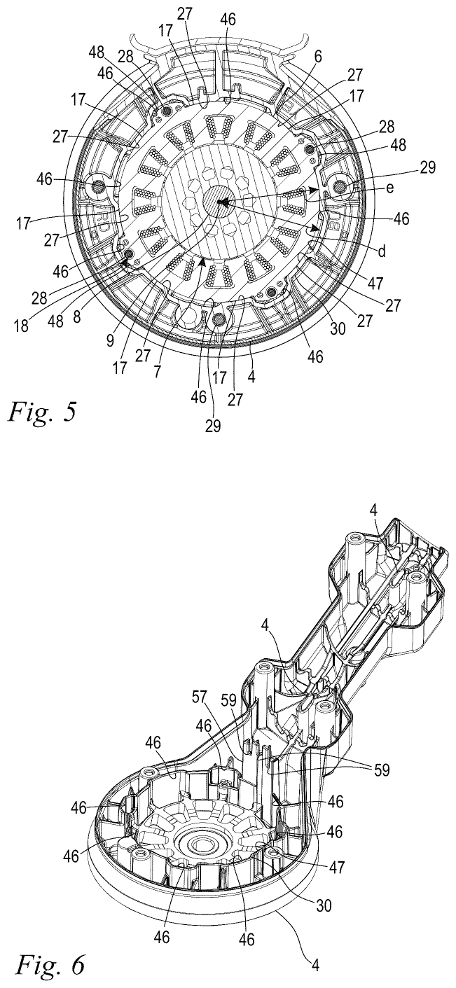

As shown in FIG. 4, the stator 6 is connected to the upper housing part 3 and the lower housing part 4 by means of a press connection. During assembly of the work apparatus 1, the stator 6 is pressed into the lower housing part 4. This results in a press connection between the second contact surface 27 of the lower housing part 4 and the centering section 17 of the stator 6, i.e. an interference fit between the lower housing part 4 and the stator 6. Subsequently, the stator 6 is screwed into the lower housing part 4 by means of screws 28 (FIG. 5). Thus, the stator 6 and the lower housing part 4 are connected to one another via a screw connection 18. The stator 6 is thus firmly connected to the lower housing part 4 both by the screw connection 18 and by the press connection. The rotor 7 is subsequently inserted into the stator 6 and the second bearing 11. Finally, the upper housing part 3 with the first contact surface 26 is pressed onto the centering section 17 and is centered relative to the stator 6, and the rotor shaft 8 is inserted into the likewise centered first bearing 10. The first contact surface 26 of the upper housing part 3 and the centering section 17 of the stator 6 also form a press connection, i.e. an interference fit between the stator 6 and the upper housing part 3. Thus, the upper housing part 3 and the lower housing part 4 are centered to each other via the stator 6. The upper housing part 3 is screwed to the lower housing part 4 using the screws 29.

FIG. 5 shows a sectional view along the section line C-C according to FIG. 4. The lower housing part 4 has several second contact surfaces 27 that contact the centering section 17 of the stator 6. The second contact surfaces 27 are formed on an inner wall 30 of the lower housing part 4. The inner wall 30 extends cylinder-like around the axis of rotation 9 of the rotor shaft 8. As shown in FIG. 5, the cylinder-like inner wall 30 has an inner side 47 facing the axis of rotation 9 of the rotor shaft 8. Several bulges 46 are provided on the inner side 47. At these bulges 46, the inner side 47 of the inner wall 30 does not contact the stator 6, in particular the centering section 17 of the stator 6. In other words, in the region of the bulge 46 the inner side 47 of the inner wall 30 is formed at a distance from the stator 6. At the bulges 46 the inner side 47 has a distance d from the axis of rotation 9 of the rotor shaft 8. The distance d is smaller than a distance e between the inner side 47 of the inner wall 30 at the contact surfaces 27 and the axis of rotation 9 of the rotor shaft 8. The bulges 46 are arranged along the inner side 47 of the inner wall 30 such that adjacent bulges 46 have substantially equal angular distances relative to the axis of rotation 9 of the rotor shaft 8. By forming the bulges 46, the flexibility of the inner wall 30 at the second contact surfaces 27 is increased radially to the axis of rotation 9 of the rotor shaft 8. If the stator 6 is pressed into the lower housing part 4, the inner wall 30 can deform radially outward at the first contact surfaces 27 that are in contact with the centering section 17 of the stator 6. The deformation is essentially elastic, which creates a spring effect. The inner wall 30 is clamped with its first contact surfaces 27 against the centering section 17 of the stator 6. The arrangement and design of the bulges 46 on the inner side 47 of the inner wall 30 of the lower housing part 4 enables elastic deformability of the inner wall 30 in the region of the second contact surfaces 27 radially outward relative to the axis of rotation 9 of the rotor shaft 8.

As shown in FIGS. 5 and 6, eight bulges 46 are provided on the inner side 47 of the inner wall 30 of the lower housing part 4. A different number of bulges 46 may also be appropriate to ensure the elastic deformation described above. Projections 48 of the stator 6 extend into four bulges 46, via which the stator 6 is screwed to the lower housing part 4 (FIG. 5). The screws 28 protrude in the direction of the axis of rotation 8 through the projections 48 of the stator 6.

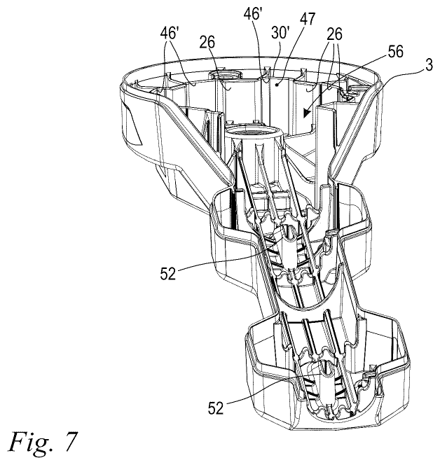

As shown in FIG. 7, analogously to the lower housing part 4, bulges 46′ are also formed on the upper housing part 3 on an inner side 47′ of an inner wall 30′ of the upper housing part 3. The function of these bulges 46′ of the upper housing part 3 corresponds to the above description with regard to the bulges 46 of the lower housing part 4. Thus, the inner wall 30′ of the upper housing part 3 is also designed to be elastically deformable radially outward relative to the axis of rotation 9 of the rotor shaft 8 in the region of the first contact surface 26. A press connection can thus be produced between the second contact surfaces 26 of the upper housing part 3 and the centering section 17 of the stator 6.

As shown in FIG. 3, the housing 2 has a receptacle 12 for the tube 13. The receptacle 12 is delimited by the upper housing part 3 and the lower housing part 4. In particular, the receptacle 12 is formed by the upper housing part 3 and the lower housing part 4. The receptacle 12 has a receiving section 51 along which the tube 13 extends into the housing 2. Fastening elements 52, on which the tube 13 is held, are formed on the housing 2 in the receiving section 51. In the exemplary embodiment, the fastening elements 52 are conical. In the exemplary embodiment, anti-vibration elements 53 are fastened to the fastening elements 52 in order to decouple the tube 13 from the housing 2 and the electric motor 5 with regard to vibrations. The conical fastening elements 52 protrude into openings 54 of the tube 13. The anti-vibration elements 53 are designed in such a way that, on the one hand, they rest on an outer side 55 of the tube 13 and, on the other hand, protrude into the openings 54 of the tube 13. Consequently, the tube 13 is secured through both frictional engagement and positive connection by the anti-vibration elements 53. An arrangement without anti-vibration elements 53 and/or differently designed fastening elements 52 can also be provided. Two fastening elements 52 are formed on the upper housing part 3 and are arranged at a distance from one another (FIG. 7). Two fastening elements 52 are likewise formed on the lower housing part 4 and are arranged at a distance from one another (FIG. 6). In the receiving section 51, the upper housing part 3 and the lower housing part 4 are connected to one another, in particular via four screws 29. The tube 13 is clamped between the upper housing part 3 and the lower housing part 4. The upper housing part 3 and the lower housing part 4 are supported on the tube 13 in the receiving section 51, so that the tube 13 also contributes to the stiffening of the housing 2.

As shown in FIG. 3, the receiving section 51 extends to the inner walls 30, 30′ of the upper housing part 3 and the lower housing part 4. The tube 13 projects beyond the inner wall 30 of the lower housing part 4 in a direction radial to the axis of rotation 9 of the rotor shaft 8. The small distance between the electric motor 5 and the tube 13 ensures that the construction of the work apparatus 1 is as rigid as possible. As shown in FIGS. 3 and 7, a recess 56, through which the tube 13 projects, is provided on the inner wall 30′ of the upper housing part 3. An elevation 57 is formed on the inner wall 30 of the lower housing part 4, which extends approximately up to the cross-sectional center of the tube end 58. Cable holders 59 are provided on the elevation 57 of the inner wall 30 of the lower housing part 4 (FIG. 7). Power cables 60 are attached to the cable holders 59, via which the electric motor 5 is electrically connected to the battery pack 40.

After the stator 6 has been inserted into the lower housing part 4, the tube 13 can also be inserted into the receiving section 51 of the lower housing part 4, and in particular the power cables 60 can be fixed to the cable holder 59. By mounting the upper housing part 3 on the lower housing part 4, on the one hand, the rotor shaft 8 is completely mounted and, on the other hand, the tube 13 is clamped. This increases productivity in the production of the work apparatus 1.

As shown in FIG. 3, the work apparatus 1 includes a fan wheel 42 disposed on the rotor shaft 8 adjacent the lower housing part 4. The fan wheel 42 generates an air flow for cooling the electric motor 5 that is arranged in the housing 2. A fastening device 43 for connecting a mowing head is provided on the fan wheel 42. Part of the fastening device 43 is a nut 44 that is screwed onto the rotor shaft 8. The nut 44 clamps the fan wheel 42 against the lower housing part 4, in particular against the second bearing 11 that is fastened in the lower housing part 4. The outer contour of the nut 44 is designed as a splined shaft for receiving the mowing head 19 in a form-fitting manner. The mowing head 19 is seated in a form-fitting manner on the nut 44, as a result of which the latter is held in a rotationally secure manner on the rotor shaft 8. In addition, the fastening device 43 comprises an actuating element 45 which serves to axially secure the mowing head 5 in the direction of the axis of rotation 9 of the rotor shaft 8 by means of a holding contour 49. The actuating element 45 is accessible to the operator and can be operated manually. To release the axial securing of the mowing head 5, the operator must manually press the actuating element 45 radially to the axis of rotation 9. The axial lock is then unlocked, whereby the mowing head 5 can be pulled off the nut 44.

What is claimed is:

1. A handheld work apparatus, comprising
a housing (2) with an upper housing part (3) and a lower housing part (4);
a drive motor (5) arranged in the housing (2),
wherein the drive motor (5) is an electric motor and has a stator (6) connected to the housing (2) and a rotor (7), and
wherein a rotor shaft (8) of the rotor (7) is mounted relative to the housing (2) by a first bearing (10) and a second bearing (11) so as to be rotatable about an axis of rotation (9), and
wherein the rotor shaft (8) extends in a direction of the axis of rotation (9) from the upper housing part (3) into the lower housing part (4), and
wherein the first bearing (10) is held by the upper housing part (3), and
wherein the second bearing (11) is held by the lower housing part (4); and
a receptacle (12) formed at least partially on the upper housing part (3) for fastening a tube (13) to the housing (2),
wherein the upper housing part (3) and the lower housing part (4) at least partially overlap the stator (6) in the direction of the axis of rotation (9) of the rotor (7).

2. The handheld work apparatus according to claim 1,
wherein the upper housing part (3) and the lower housing part (4) have a separating plane (16) running transversely to the axis of rotation (9) in a region of the stator (6).

3. The handheld work apparatus according to claim 1,
wherein the first bearing (10) and/or the second bearing (11) are overmolded or pressed into the upper housing part (3) or into the lower housing part (11) respectively.

4. The handheld work apparatus according to claim 1,
wherein the upper housing part (3) and/or the lower housing part (4) are made of plastic.

5. The handheld work apparatus according to claim 1,
wherein the stator (6) is pressed into the upper housing part (3) or into the lower housing part (4).

6. The handheld work apparatus according to claim 1,
wherein the upper housing part (3) and the lower housing part (4) are centered relative to one another via the stator (6).

7. The handheld work apparatus according to claim 1,
wherein the stator (6) has a centering section (17) on its circumference, and
wherein the stator (6) directly contacts the lower housing part (4) and/or the upper housing part (3) via the centering section (17).

8. The handheld work apparatus according to claim 7,
wherein the centering section of the stator (6) has a length (a) measured in the direction of the axis of rotation (9) of the rotor (7),
wherein the upper housing part (3) contacts the stator (6) on the centering section (17) via a first contact surface (26),
wherein the upper housing part (3) overlaps the centering section (17) of the stator (6) with its first contact surface (26) in the direction of the axis of rotation (9) of the rotor in a first overlap section (14), and
wherein a length (b) of the first overlap section (14) measured in the direction of the axis of rotation (9) corresponds to at least 20% of the length (a) of the stator (6).

9. The handheld work apparatus according to claim 1,
wherein the stator (6) is fastened to the lower housing part (4) via a screw connection (18).

10. The handheld work apparatus according to claim 1,
wherein the receptacle (12) for fastening the tube (13) is formed from the upper housing part (3) and the lower housing part (4).
